(19) United States
(12) Patent Application Publication
(10) Pub. No.: US 2004/0008366 A1
(43) Pub. Date: Jan. 15, 2004

(54) Print job requirement-based selection of best-fit printing device

(76) Inventor: Andrew R. Ferlitsch, Tigard, OR (US)

Correspondence Address: David C. Ripma, Patent Counsel, Sharp Laboratories of America, Inc., 5750 NW Pacific Rim Boulevard, Camas, WA, 98607, US

(21) Appl. No.: 10/196,544

(22) Filed: Jul. 15, 2002

(51) Int. Cl. B41J 1/00; B41F 1/00; G06F 15/00

(52) U.S. Cl. 358/1.15; 358/1.14

(57) ABSTRACT

A computer-based system and method for matching a print job to the most appropriate one or more nominally available plural printers, or printing devices. The system and method are based upon an approach which utilizes primary-level system broadcasting of a specific print-job's requirements to define printer selection. Where important, conflicting broadcast responses received from two or more printers triggers secondary-level interrogation in order to resolve the conflict.

### BACKGROUND AND SUMMARY OF THE INVENTION

This invention relates to the selection of a printing device from a plurality of such devices for executing a particular print job. More specifically, the invention offers novel structure and methodology for performing such a selection which is based principally upon the specific printing requirements associated with a selected print job.

In the traditional implementation of a print job, once that job is created and defined, if there are a plural printing devices nominally available to implement the job, selection of a single device from that plurality typically takes place either through user selection, based upon the user's understanding of the respective printers' capabilities, or, in some instances, upon the use of a device-discovery algorithm which requests a report from each of the plural, available printers respecting their particular capabilities. From this report, either a user may “manually” perform the necessary device selection, or an appropriate, best-fit-type algorithm may be employed to make the choice.

Those skilled in the art, familiar with this matter of printing device selection will recognize that there are many important requirements/considerations that are attached to different print jobs, and that differ from print job to print job. Such requirements and considerations might include, for example, but are certainly not limited to, page printing speed, time to true availability of a printing device to take on a job, sheet assembly and finishing capabilities, such as stapling, hole punching, etc., capabilities to offer different paper stocks, collating capabilities, PDL interpretation capabilities, color printing image-manipulation capabilities, and so on.

As was mentioned briefly above, traditional prior art practice often involves manual selection of a printing device for a print job, such selection being based chiefly on a user's personal knowledge, or believed knowledge, regarding the capabilities of the several printers installed and supposedly available at a particular point in time. This approach obviously suffers from the fact that a user's knowledge may not be completely adequate to identify and select printers having the most correct job-match of best-available capabilities. This situation results in, for example, unprintable or poorly printed jobs, mistakes in collation, poor attention to printing speeds and color-handling capability, and other difficulties. Incorrect understandings on the parts of users regarding real printer capabilities, can clearly result in a particular print job not being handled at all, not being handled completely, significantly delayed, and other undesirable things.

Prior art device discovery approaches, which do not rely upon a user's personal knowledge of printer capabilities, may also lead to disappointing consequences and results, inasmuch as traditional job/printing-device matching modalities do not take into account specific printing requirements that are associated with different print jobs.

In all such illustrations of such selection practices, selection is made essentially without specific reference being made to particular print-job requirements, which requirements are linked uniquely, and differently, to different print jobs.

The present invention steps significantly apart from this prior art practice, by basing printing-device selections specifically upon the actual printing requirements that are associated with different jobs.

According to a preferred manner of practicing the invention, when a print job has been created, its particular printing requirements are identified and assessed, and these requirements are, in accordance with the invention, broadcast generally to the population of nominally currently available plural printers (printing devices). This broadcast effectively requests that the receiving printers report back, so-to-speak, with relevant information regarding how their currently available printing availabilities and capabilities match with a specific print-job's requirements.

Various embodiments of the invention, all of which address this job-matching issue in very practical and satisfactory manners, and specifically in manners which utilizes print-job requirements as the defining basis for selecting the best-fit printing device, are disclosed and described herein. All such embodiments are operative in accordance with core features of the present invention, and all offer distinct performance advantages over the prior art. The various features and advantages that are contributed by the present invention will become more fully apparent as the description which now follows is read in conjunction with the accompanying drawings.

### DESCRIPTION OF THE DRAWINGS

FIG. 1 is a block/schematic diagram illustrating a computer-based system designed to handle different print jobs, and plural printing devices that are connected for access and use in the system in a setting employing the special operational and structural features of the present invention.

FIG. 2 is a block/schematic diagram illustrating driver-based printer broadcast messaging and response carried out in accordance with the invention.

FIG. 3 is a block/schematic diagram picturing driver-based, peer-to-peer, printer best-fit selection performed in accordance with practice of the present invention.

FIG. 4 illustrates, in block/schematic format, the practice of driver-based, network-queue, printer best-fit selection performed according to the methodology of the invention.

FIG. 5 shows, in block/schematic form, spooler/print-processor-based printer broadcast messaging and response carried out in accordance with practice of the present invention.

FIGS. 5A and 5B show two modified invention embodiments based upon what is shown in FIG. 5. FIG. 5A illustrates a print-assist-based approach, and FIG. 5B a driverless approach.

FIG. 6 shows, in the format of a block/schematic pictorial diagram, spooler/print-processor-based, peer-to-peer, printer best-fit selection carried out in accordance with practice of this invention.

FIG. 7 illustrates, as a block/schematic diagram, driver-based, network-queue, printer best-fit selection as implemented in accordance with the methodology of the present invention.

### DETAILED DESCRIPTION OF THE INVENTION

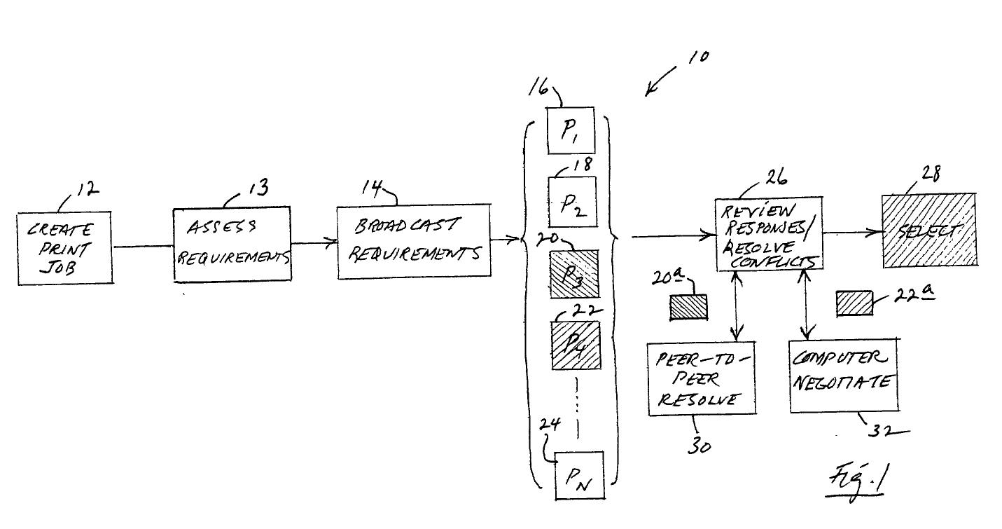

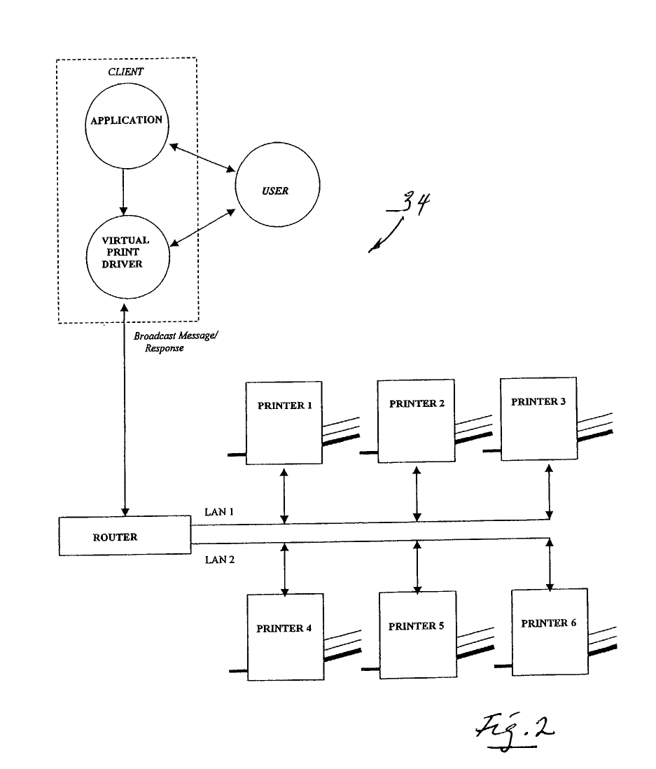

Turning now to the drawings, and referring first of all to FIG. 1, here there is shown generally at 10 a system constructed in accordance with the present invention. This system performs in accordance with the methodology of the invention to select, from an available group of plural printers, or printing devices, the one (or several) best-fit printer(s) or printing device(s) which possesses current availability, and a range of capabilities, that most nearly meet the actual printing requirements that are associated with different, selected printing jobs.

Represented in FIG. 1, as componentry and methodology associated with and in system 10, is a block 12 which represents the creation of a print job in apparatus such as a client computer armed with an appropriate document-creating application. Block 12 is also referred to herein as creation structure. Also present in the system are a block 13 which identifies and assesses specific print-job requirements (requirement-assessment structure), a block 14 which implements print-job-requirements broadcasting according to the invention, and five blocks designated 16, 18, 20, 22, 24, which represent plural, nominally available printing devices that are accessible within system 10. These devices are “internally” labeled in FIG. 1 with the designators P1, P2, P3, P4, and P_{N}.

Shown to the right of this collection of plural printing devices in FIG. 1 is a block 26 which implements reviews of responses that are received from the individual printing devices—responses returned in relation to inquiries about how their respective availabilities and capabilities match up with specific job requirements. Block 26 which co-acts with block 14 to form printing-device discovery structure in system 10 also implements, selectively, one of two different illustrated kinds of conflict resolution (peer-to-peer, and computer-to-printer negotiation)—a resolution which is necessary when “first-level” responses produce a condition that does not clearly distinguish the single best-fit printing device to be associated with a particular printing job. Blocks 14, 26 herein are recognized as being operatively interposed block 14 and the printing/devices.

A block 28, which is positioned to the right of block 26 in FIG. 1, constitutes selection structure in system 10, and implements final selection of a best-fit printing device in accordance with the invention. Two additional blocks 30, 32 represent structure, and appropriate methodology, that are employed to implement, respectively two different, selectable ways of carrying out conflict resolution, just briefly mentioned above. Block 30 executes what is referred herein as peer-to-peer conflict resolution, and block 32 executes conflict resolution that is performed by what is referred to herein as computer-to-printer negotiation.

Further explaining generally what is pictured in FIG. 1, one will note that blocks 20, 22, which represent printing devices P3 and P4, are filled with different characters of shading. This shading has been employed in FIG. 1 (with respect to these two devices) to illustrate and to symbolize the presence of a conflict which develops in responses given by these devices to a particular broadcast of the specific requirements of a particular printing job. Small blocks that are shown at 20a and 22a which sit vertically (in FIG. 1) between block 26 and blocks 30, 32, are included to illustrate graphically that conflict resolution is to be performed with respect to conflicting responses that have been received by devices P3 and P4 in relation to the broadcast of a set of print-job requirements in system 10. Blocks 20a, 22a are illustrated with the same shading that is employed in blocks P₃, P₄, respectively.

In system 10, the five printing devices illustrated therein may be connected either locally or in a network or in a peer-to-peer printing environment, and are suitably connectable or connected to the structure (typically a client computer) which is illustrated by blocks 12, 13, 14 in FIG. 1. During use of system 10 in accordance with the invention, the computing device which is represented by blocks 12, 13, 14 is capable of initiating a print job, as from an appropriate document-creating application, and is capable of despooling that print job via a driver, to a spooler, and optionally to a print processor, and therethrough to a selected, best-fit one or several of the printers illustrated in FIG. 1. These printers include appropriate conventional firmware which has the ability to receive a broadcast message from block 14, and to respond to a requirements broadcast with various information relating to their respective current availabilites and capabilities for meeting the specific requirements of the particular print job involved.

Broadcast of print-job requirements to such a plurality of printers evokes respective responses from these printers, and as will be more fully explained and illustrated, a selection, based upon these first (or primary)-level inquiry responses, and perhaps further on secondary-level broadcasting and responding activity, selects the best-fit one, or ones, of the available printers for handling the particular print job.

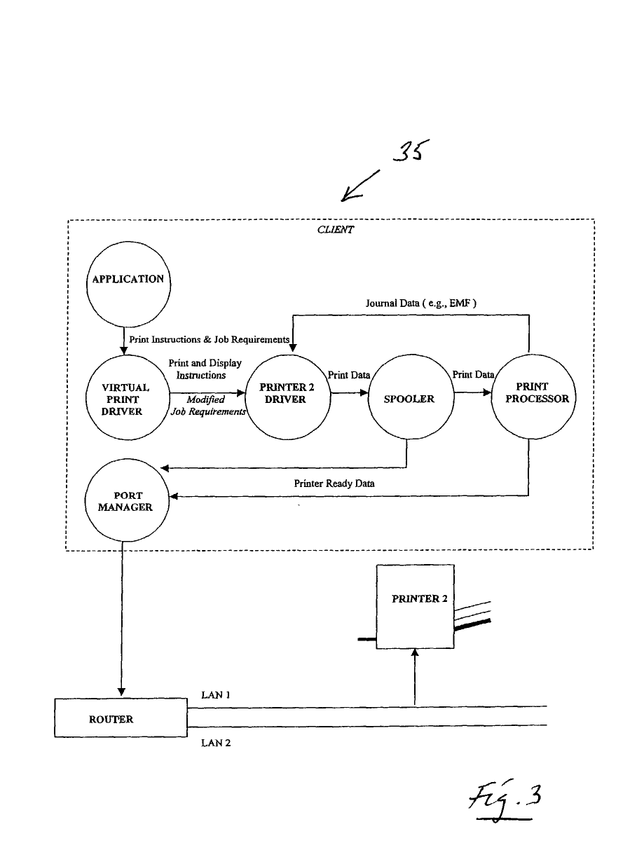

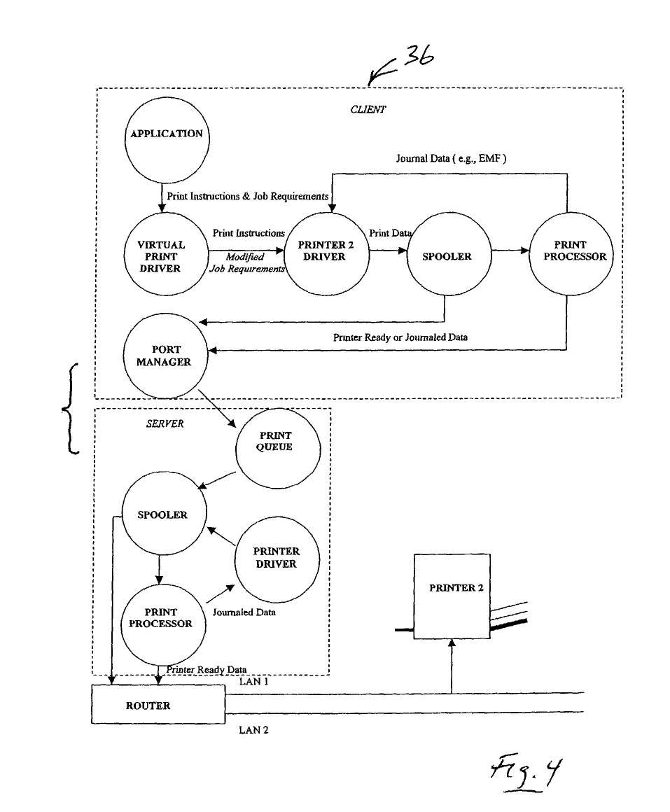

With reference now to FIGS. 2 and 3, and to Tables I, II and III below, here, what is illustrated, is an embodiment (system and method) of the present invention which is implemented as Printer Broadcast Message and Response-Driver Based, peer-to-peer activity in system 10. Very specifically, reference numeral 34 in FIG. 2, and 35 in FIG. 3, clearly picture this structural and methodological embodiment of the invention in a manner which, with little needed extra explanation, pictorially communicates to those skilled in the art how to practice this invention in accordance with this embodiment.

In this embodiment of the invention, the print job which is to be handled, and an associated display list of instructions, are sent to a virtual driver which is defined as a pass-through driver that neither journals or renders print data, or spools its output to a spooler. Instead, this virtual driver is used to identify specifically the associated print-job requirements, and a printer driver or drivers to journal or to render the relevant print data. The print job requirements, and display list of instructions, are sent to the nominally available printer drivers that are associated with the plural connection population of six different printers which are shown and appropriately labeled in FIG. 2.

The virtual driver makes a connection to these printers, and a specific print-job broadcast message is created with an appropriate format and content specific to the system and to the particular print job.

Table I here-below illustrates generally, but not exhaustively, the typical content of such a print-job broadcast message.

TABLE I
1. Identification and Type of the Computing Device for return Response
a. Machine Name
b. IP Address
c. Operating System
d. Process or Routing Information
2. Rendering Requirements
a. Copy Collation
b. Duplex
c. Color
d. Face Up
3. Finishing
a. Stapling
b. 3 Hole Punch
c. Saddle Stitch
d. Copy Offsetting
4. Capacity
a. No. of Sheets per Copy
b. No. of Copies
c. No. of Output Trays
5. Paper
a. Size/Stock
b. Manual Feeder
c. Envelope Feeder
d. Transparency Feeder

The contents of return responses from the associated printer firmware will contain information on the abilities, and degrees of the receiving printers capabilities, to meet the requirements of the particular print job. Such response information is illustrated, though not exhaustively, in Table II.

TABLE II

1. Identification of Responding Device
a. Device Name
b. IP Address
c. DNS Name
d. Printer Queue
e. Printer Location
f. Printer Model
2. Rendering Capabilities
a. Copy Collation
b. Duplex
c. Color
d. Face Up
e. PPM (Pages per Minute)
f. PDL(s)
3. Finishing Capabilities
a. Stapling
b. 3 Hole Punch
c. Saddle Stitch
d. Copy Offset
4. Capacity
a. Output Tray Capacity
b. No. of Output Trays
5. Paper Size
a. Size/Stock
b. Manual Feeder
c. Envelope Feeder
d. Transparency Feeder
6. Printer Driver Identification
a. Driver Name
b. Driver Location
7. Availability
a. Estimated Time to Availability
b. Estimated Time to Completion

In one manner of operation according to the present invention, and still speaking with reference to FIG. 2 in the drawings, each printer receiving the broadcast message will respond regardless of whether or not it can meet the minimum requirements of the print job. In a slightly modified embodiment version, only the printers that apparently meet or exceed the broadcast print-job requirements would respond. The responding printer(s) may be logical in nature, such as a group or cluster of printers, or a proxy printer, like a server processor.

In still a further embodiment of the invention based upon the architecture illustrated in FIG. 2, other preferences may be applied during the broadcast and response operation of the system of this invention, such as a proximity response. For example, a broadcast message may go out on successively physically further subnets, until the needs of a particular print job are known to be satisfiable. Other preferences which might be useful include time availability and time for completion.

In yet another modified form and manner of practicing the invention, broadcast content can be focussed, at least in part, as an inquiry regarding address enumeration, such as so-called (a) IP range, and (b) predefined set.

With reference now to Table III below, still a further embodiment of and manner of practicing the present invention are described.

TABLE III

| Broadcast Message Format | Response |
|---|---|
| Client | Printer |
| Machine Name | Printer Name |
| IP Address | IP Address |
| Operating System | DNS Name |
| Process/Routing | Printer Queue |
| | Printer Location |
| | Printer Model |
| Rendering | Rendering |
| Collation | Collation |
| Duplex | Duplex |
| Color | Color |
| Face Up | PPM |
| | PDL 1 |
| | PDL 2 |
| | . . . |
| Finishing | Finishing |
| Stapling | Stapling |
| 3 Hole Punch | 3 Hole Punch |
| Saddle Stitch | Saddle Stitch |
| Copy Offsetting | Copy Offsetting |
| Capacity | Capacity |
| No. of Sheets per Copy | Output Tray Capacity |
| No. of Copies | No. of Output Trays |
| No. of Output Trays | |
| Paper | Paper |
| Size 1 & Stock | Size 1 & Stock |
| Size 2 & Stock | Size 2 & Stock |
| Size 3 & Stock | Size 3 & Stock |
| . . . | . . . |
| Transparency | Transparency |
| Manual Feed | Manual Feed |
| Envelope Feed | Envelope Feed |
| | Driver |
| | Driver Name |
| | Driver Location |
| | Availability |
| | Estimated Time to Availability |
| | Estimated Time to Complete |

In this illustration of the invention, printer firmware will take the requirements of a print job as broadcast to that firmware to estimate when the print job could be completed. In still a further embodiment of the invention, the client computing device which is involved in the system of the invention takes the requirements of a particular print job, along with information on the capabilities of printers, including possibly heuristic information on various printers past actual performances, and regarding current jobs spooled to associated printers, to estimate when a print job could be completed.

Referring to FIG. 3 in the drawings, an embodiment and practice of the invention are here illustrated wherein the associated computing device processes all of the responses received from queried printers, and selects one (non-cluster), or more (cluster) printing devices to which to de-spool the print job(s). This process of selection may be manually decided by the user, or by an automated process based on preferences, or combinations thereof, such as time to completion, accuracy in assembly, proximity to operator, cost of consumables, and other matters.

Once a printing device or devices is/are selected, the appropriate virtual print driver passes the print and display instructions to the respective printer driver, or drivers, associated with the selected printer, or printers. In an alternative embodiment, the response from a printing device includes the name and location of the printer driver on an associated network, such a print server.

The appropriate printer driver(s) then journals or renders the print and display instructions, and spools the print data to the spooler. The spooler then de-spools the print data to the print processor, or directly to the port manager(s) associated with the specified printing device(s). If the print data is rendered, the print processor writes the printer ready data directly to the port manager, or managers, associated with the specified printing device(s). If data is journaled, the print processor plays back the data to the respective printer driver(s), which then renders the journal data, and passes the printer ready data back to the spooler. The spooler then writes the printer ready data directly to the port manager(s) associated with the specified printing devices(s).

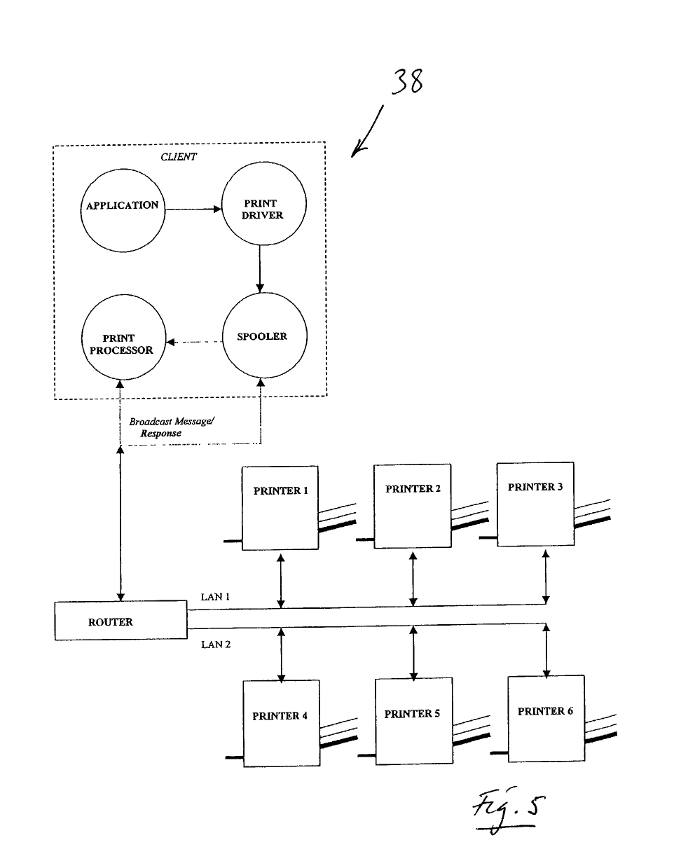

With attention now directed to reference numeral 36 in FIG. 4 in the drawings, here, there is illustrated an embodiment of the invention which takes the form of a network queue printing environment. In this embodiment and practice of the invention, the steps and activities that are invoked follow generally the same processes and procedures described above, with certain exceptions, some of which will now be generally described.

The port manager(s) are associated with print queues on a print server. The print data is de-spooled to the network queue for deferred de-spooling to the printing device(s) by the print server's spooler.

The print data de-spooled to the print queues may be journaled data for deferred rendering by printer driver(s) installed on the print server.

In a somewhat alternative or modified form of the embodiment pictured in FIG. 4, where the printer driver is not present on the relevant client computing device, printer response may indicate that the location is on the server, in which case, the printer driver(s) need not be installed in the client.

Not all print jobs that are de-spooled to the responding printing device(s) may be spooled on the printing devices themselves. Instead, some print jobs may still reside on print queues waiting to be de-spooled. The information received by the computing device from print job requirements broadcasting can be further combined with information that is obtained from the print queues on jobs that are not yet de-spooled to the printing devices.

These activities will be apparent to those generally skilled in the art on specifically reviewing the contents of FIG. 4 herein.

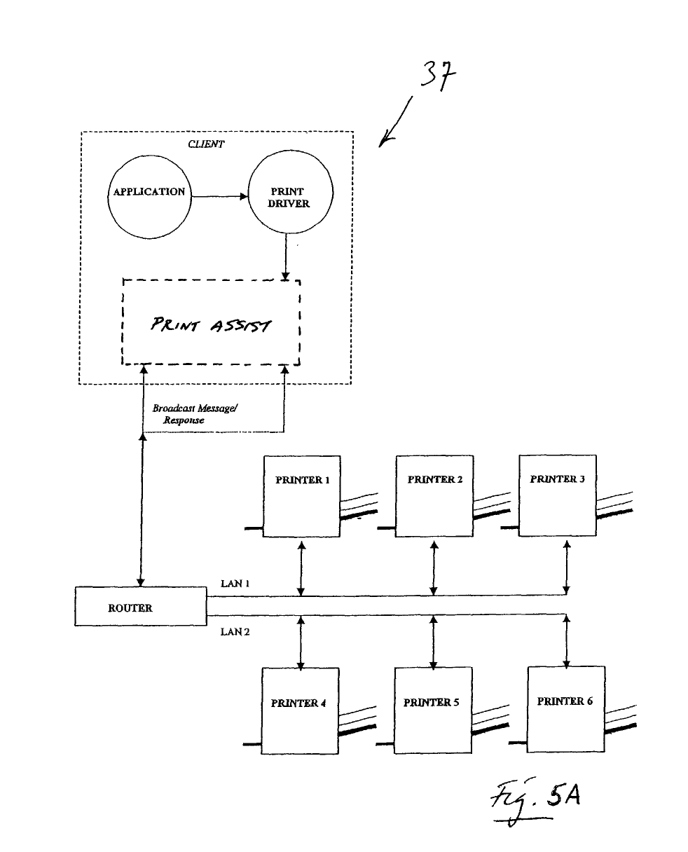

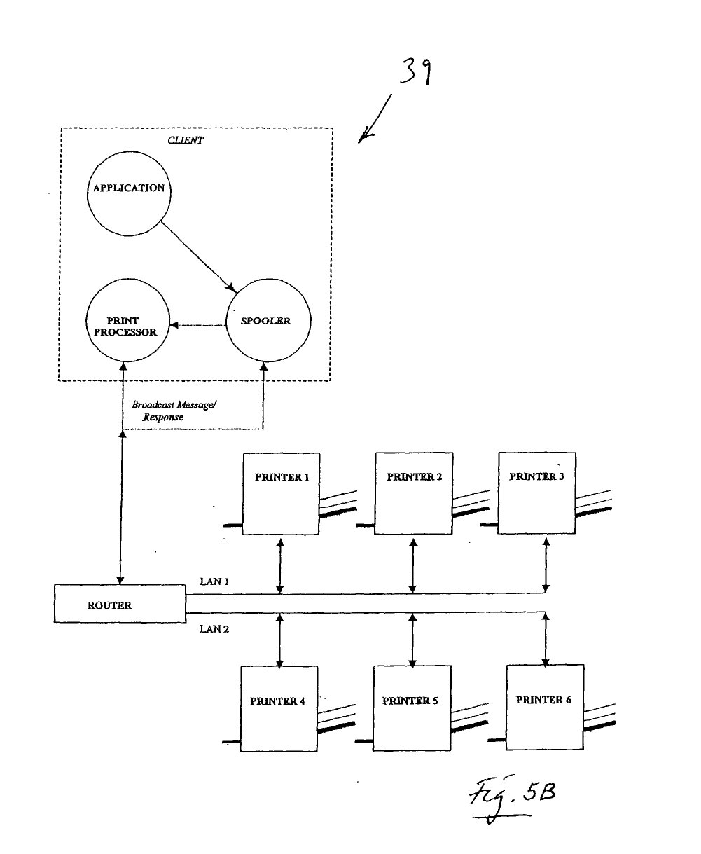

Addressing now attention to reference numeral 38 in FIG. 5, in this embodiment of the invention, the print job and display list instructions are sent to a specified printer driver. The printer driver then renders or journals the print and display instructions, and spools the print data to the spooler.

In one manner of practicing the invention in accordance with what is shown in FIG. 5, the spooler makes a connection to one or more local area networks, or to wide area networks. Local area networks may be specified by the user, pre-configured, specified by an automated or background process, or by an auto-discovery mechanism.

In another version of practice of the invention based upon what is shown in FIG. 5, the spooler de-spools the print data to the print processor, and the spooler makes a connection to one or more local area networks, or to one or more wide area networks, depending upon system configuration.

On each local area network, and sub-nets within, a single broadcast message is sent out according to the invention, which message is received and read by each active device connected in that local area network. The print-job broadcast message is of course of an appropriate format to communicate accurately to the associated potentially available plurality of printing devices.

FIG. 5A shows at 37, and FIG. 5B at 39, two further modifications of the invention relating, respectively, to a print-assist approach, and to a driverless approach.

Tables IV and V below illustrates, respectively the content of print-job requirement broadcasting in this embodiment of the invention, and return-response reply content received from the relevant printing devices.

TABLE IV
1. Identification and Type of the Computing Device for return Response
a. Machine Name
b. IP Address
c. Operating System
d. Process of Routing Information
2. Rendering Requirements
a. Copy Collation
b. Duplex
c. Color
d. Face Up
e. PDL type
3. Finishing
a. Stapling
b. 3 Hole Punch
c. Saddle Stitch
d. Copy Offsetting
4. Capacity
a. No. of Sheets per Copy
b. No. of Copies
c. No. of Output Trays
5. Paper
a. Size/Stock
b. Manual Feeder
c. Envelope Feeder
d. Transparency Feeder

TABLE V

1. Identification on Responding Device
a. Device Name
b. IP Address
c. DNS Name
d. Printer Queue
e. Printer Location
f. Printer Model
2. Rendering Capabilities
a. Copy Collation
b. Duplex
c. Color
d. Face Up
e. PPM (Pages per Minute)
f. PDL(s)
3. Finishing Capabilities
a. Stapling
b. 3 Hole Punch
c. Saddle Stitch
d. Copy Offsettin
4. Capacity
a. Output Tray Capacity
b. No. of output Trays
5. Paper
a. Size/Stock
b. Manual Feeder
c. Envelope Feeder
d. Transparency Feeder
6. Printer Driver Identification
a. Driver Name
b. Driver Location
7. Availability
a. Estimated Time to Availability
b. Estimated Time to Completion

Still a further embodiment of this invention is illustrated in Table VI. This embodiment is referred to as Broadcast Message & Response Content—Spooler/Print Processor Based.

TABLE VI

| Broadcast message Format | Response |
|---|---|
| Client | Printer |
| Machine Name | Printer Name |
| IP Address | IP Address |
| Operating System | DNS Name |
| Process/Routing | Printer Queue |
| | Printer Location |
| | Printer Model |
| Rendering | Rendering |
| Collation | Collation |
| Duplex | Duplex |
| Color | Color |
| Face Up | Face Up |
| PDS | PDL(s) |
| | PPM |
| Finishing | Finishing |
| Stapling | Stapling |
| 3 Hole Punch | 3 Hole Punch |
| Saddle Stitch | Saddle Stitch |
| Copy Offsetting | Copy Offsetting |
| Capacity | Capacity |
| No. of Sheets per Copy | Output Tray Capacity |
| No. of Copies | No. of Output Trays |
| No. of Output Trays | |
| Paper | Paper |
| Size 1 & Stock | Size 1 & Stock |
| Size 2 & Stock | Size 2 & Stock |
| Size 3 & Stock | Size 3 & Stock |
| . . . | . . . |
| Transparency | Transparency |
| Manual Feed | Manual Feed |
| Envelope Feed | Envelope Feed |
| | Availability |
| | Estimated Time to Availability |
| | Estimated Time to Complete |

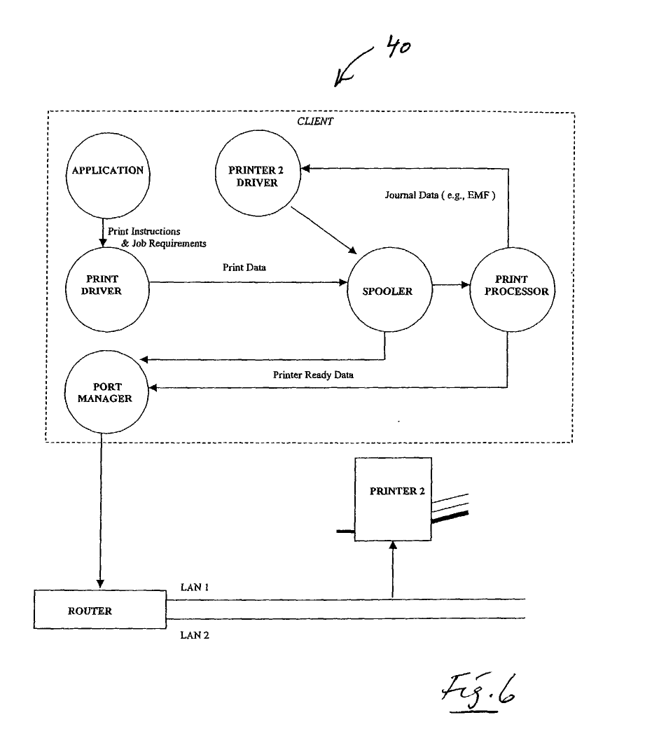

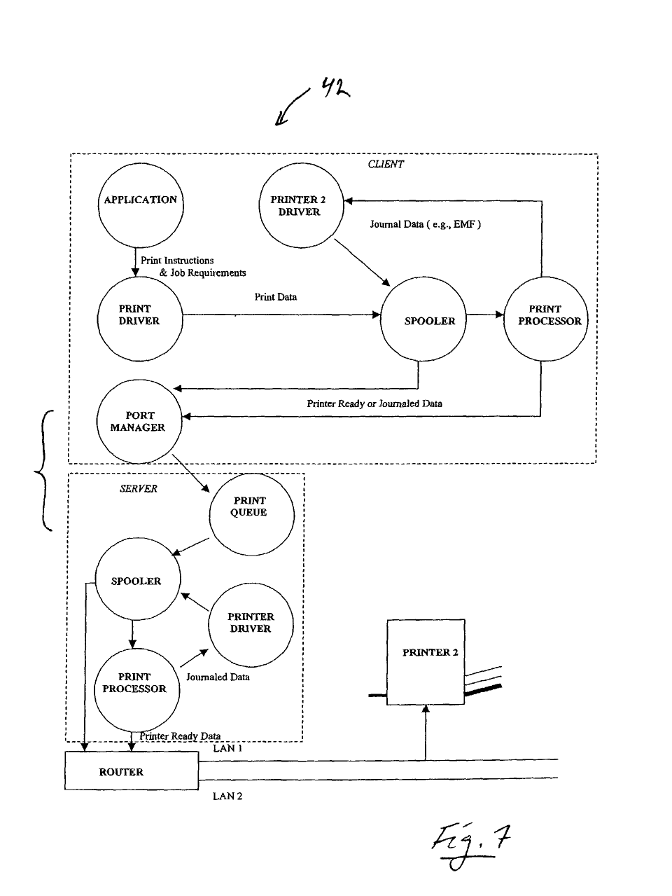

FIGS. 6 and 7 in the drawings illustrate at 40, 42, respectively, two additional embodiments and manners of practicing the invention. From the various embodiments that have been described above, it should be apparent to those skilled in the relevant art how practices in accordance with FIGS. 6 and 7 can be implemented and performed in accordance with the present invention. Accordingly, detailed elaboration of these two additional invention embodiments are not presented other than in the fully detailed graphical format presented in these two figures.

It should thus be apparent how the system and methodology proposed by the present invention uniquely makes more effective and practical and economical the selection of a particular printer, or particular printers, from a larger plurality of nominally available printers, for the purpose of establishing a best-fit match between a selected printer or printers and a particular print-job's specific printing requirements. Every embodiment of the invention which has been disclosed and illustrated herein, operates on the basis of specific print-job requirements, rather than upon a less accurate, prior art type of assessment which does not begin with print-job requirements as a key, defining template for selecting (matching) one or more printing devices to perform a job.

The invention deals with time-variant availabilities and capabilities of nominally available printing devices each time that a print job is called for. If first-level, or primary, printing-device interrogation results in a plural-printer-response conflict situation, at least one secondary interrogation takes place, as illustrated in FIG. 1, to resolve the conflict. For example, one manner of secondary-interrogation resolution involves client (computer-to-printer) interrogation. As another example, secondary resolution interrogation can be handled in a peer-to-peer manner employing a conflict resolution dialog between the conflicting, responding printers themselves. In yet another approach to conflict resolution, a client computer is called upon to make an arbitrary choice to solve the issue.

While various embodiments and manners of practicing the invention have been illustrated and described herein, it should be very evident to those skilled in the art that many variations and other modalities of practice can be implemented within the scope of this invention, and all such additional embodiments and modalities are considered to be a part of the invention.

I claim:

1. A method for matching a print job to the most appropriate one, or several, of plural, nominally available printing devices comprising
identifying a print job's printing requirements, and
following said identifying, using those identified requirements as the defining parameters for selecting such a printing device, or devices, best suited for executing the requirements.

2. A computer-based method for matching a subject print job to the most appropriate one, or several, of plural, nominally available printing devices comprising
identifying a print job's printing requirements,
broadcasting those requirements to a population of available printing devices to generate responses from those devices that relate to their respective current printing capabilities relative directly to the broadcast requirements, and
utilizing those responses, selecting the most appropriate, responding printing device, or devices, for execution of the subject print job.

3. The method of claim 2 which recognizes and takes into account the fact that the different available printing devices may possess dynamic, time-variant, current printing availabilities and capabilities.

4. The method of claim 2, wherein responses from the printing devices may create a conflict situation, in the sense that two or more such devices appear to be substantially equally appropriate as a selection for use, and the method further includes the step of performing availability and capability conflict resolution in order to form an operative judgement about which device, or devices, to select.

5. The method of claim 4, wherein said broadcasting takes the form, effectively, of a primary level of inquiry regarding current printing device capabilities, and such conflict resolution involves a secondary level of inquiry which elicits responses from the conflicting devices that further detail the meanings of their respective, first-level conflicting responses.

6. The method of claim 4, wherein conflict resolution is performed in a printing-device, peer-to-peer manner of activity.

7. The method of claim 4, wherein conflict resolution is performed in a computer-to-printing-device negotiating manner of activity.

8. The method of claim 5, wherein conflict resolution is performed in a printing-device, peer-to-peer manner of activity.

9. The method of claim 5, wherein conflict resolution is performed in a computer-to-printing-device negotiating manner of activity.

10. A print-job/printing-device-capability computer-based system for handling print jobs comprising
print-job creation structure,
plural, available printing devices,
print-job requirement-assessment structure operatively connected to said creation structure, and operable to identify and assess the particular printing requirements associated with different print jobs created by the creation structure,
printing-device discovery structure operatively interposed said assessment structure and said printing devices, operable to interrogate said devices to elicit therefrom responses detailing their respective current capabilities as such relate to a given current print-job's identified printing requirements, and
selection structure operatively established in the system for selecting, based on the outcome of the interrogation performed by said discovery structure, the printing device, or devices, then best matched to the particular print job's printing requirements.

11. The system of claim 10 wherein said printing-device discovery structure is constructed to operate with at least primary and secondary levels of discovery, with the secondary level of discovery being designed to aid in the resolution of conflicts which exist between plural computers whose responses to primary level interrogation tend to indicate that two or more printing devices are equally capable of handling a particular print job.
